(19) United States
(12) Patent Application Publication
(10) Pub. No.: US 2010/0231792 A1
(43) Pub. Date: Sep. 16, 2010

(54) SEAMLESSLY CYCLED VIDEO RESOURCES

(75) Inventors: Sean K. Sharma, San Jose, CA (US); Bradley R. Pettit, Los Gatos, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/403,226

(22) Filed: Mar. 12, 2009

(51) Int. Cl. H04N 5/45; H04N 5/50

(52) U.S. Cl. 348/565; 348/570; 348/731; 348/E05.097; 348/E05.112

(57) ABSTRACT

Embodiments of seamlessly cycled video resources are described. In embodiments, program previews can be displayed where each program preview corresponds to a channel that is user-selectable for viewing a program. A subsequent channel can be determined that is user-selectable to display a program preview of an additional program, where the subsequent channel is included in a channel list that sequentially lists the channels. The subsequent channel that corresponds to the additional program can be pre-tuned before the subsequent channel is selected to display the program preview of the additional program.

### BACKGROUND

Viewers have an ever-increasing selection of media content to choose from, such as television programming, movies, videos, and music that is available for selection and/or viewing. Given the large volume of the various types of media content to choose from, viewers utilize program guides and other program preview systems to preview media content for selection and viewing. Viewers are also accustomed to instantaneous content display, such as when changing television channels in an analog television system, or when accessing Internet sites and pages with a fast computer. When a viewer selects a channel or service in a digital television system to display a program for viewing, or scrolls through a preview list of channels, a software and/or hardware tuning delay may be perceptible to the viewer, and the television system may appear to be slow or non-instantaneous.

### SUMMARY

This summary is provided to introduce simplified concepts of seamlessly cycled video resources. The simplified concepts are further described below in the Detailed Description. This summary is not intended to identify essential features of the claimed subject matter, nor is it intended for use in determining the scope of the claimed subject matter.

Embodiments of seamlessly cycled video resources are described. In embodiments, program previews can be displayed where each program preview corresponds to a channel that is user-selectable for viewing a program. A subsequent channel can be determined that is user-selectable to display a program preview of an additional program, where the subsequent channel is included in a channel list that sequentially lists the channels. The subsequent channel that corresponds to the additional program can be pre-tuned before the subsequent channel is selected to display the program preview of the additional program. The program preview of the additional program can then be displayed without a viewer-perceptible delay when a selection of the subsequent channel is received.

In other embodiments, the program previews can each be displayed as a picture-in-picture in a display configuration that represents the channel list of the sequential channels that each correspond to a respective program preview. The program preview of the additional channel can be displayed with the program previews when a user-selection of the subsequent channel is received as a scroll input of the channel list. Alternatively and/or in addition, the program previews can each be displayed in a program guide as text and/or video that corresponds to a respective program and an associated channel. The additional program can be displayed in the program guide when a selection of the subsequent channel is received as a scroll input of the program guide.

### BRIEF DESCRIPTION OF THE DRAWINGS

Embodiments of seamlessly cycled video resources are described with reference to the following drawings. The same numbers are used throughout the drawings to reference like features and components:

FIG. 1 illustrates an example system in which embodiments of seamlessly cycled video resources can be implemented.

FIG. 2 illustrates example method(s) for seamlessly cycled video resources in accordance with one or more embodiments.

FIG. 3 illustrates example method(s) for seamlessly cycled video resources in accordance with one or more embodiments.

FIG. 4 illustrates example method(s) for seamlessly cycled video resources in accordance with one or more embodiments.

FIG. 5 illustrates various components of an example device that can implement embodiments of seamlessly cycled video resources.

### DETAILED DESCRIPTION

Embodiments of seamlessly cycled video resources provide that program previews of television channels can be pre-tuned to the television channels that a viewer is likely to next select when cycling or scrolling through a list of the program previews. A viewer can scroll the program previews that are displayed to view previous television channels in a channel list. Alternatively, the viewer can scroll the program previews to view a subsequent television channel and any number of successive television channels that are listed in the channel list. The television channels that are not displayed (i.e., the program previews that are outside of the visible scope on a display) are pre-tuned just ahead of the scroll direction or direction that the program previews are being displayed for review by a viewer. A viewer can then seamlessly cycle through the program previews, in either direction, and the subsequent and successive program previews are rendered for display without a viewer-perceptible delay when a selection of a television channel is initiated by the viewer.

While features and concepts of the described systems and methods for seamlessly cycled video resources can be implemented in any number of different environments, systems, and/or various configurations, embodiments of seamlessly cycled video resources are described in the context of the following example systems and environments.

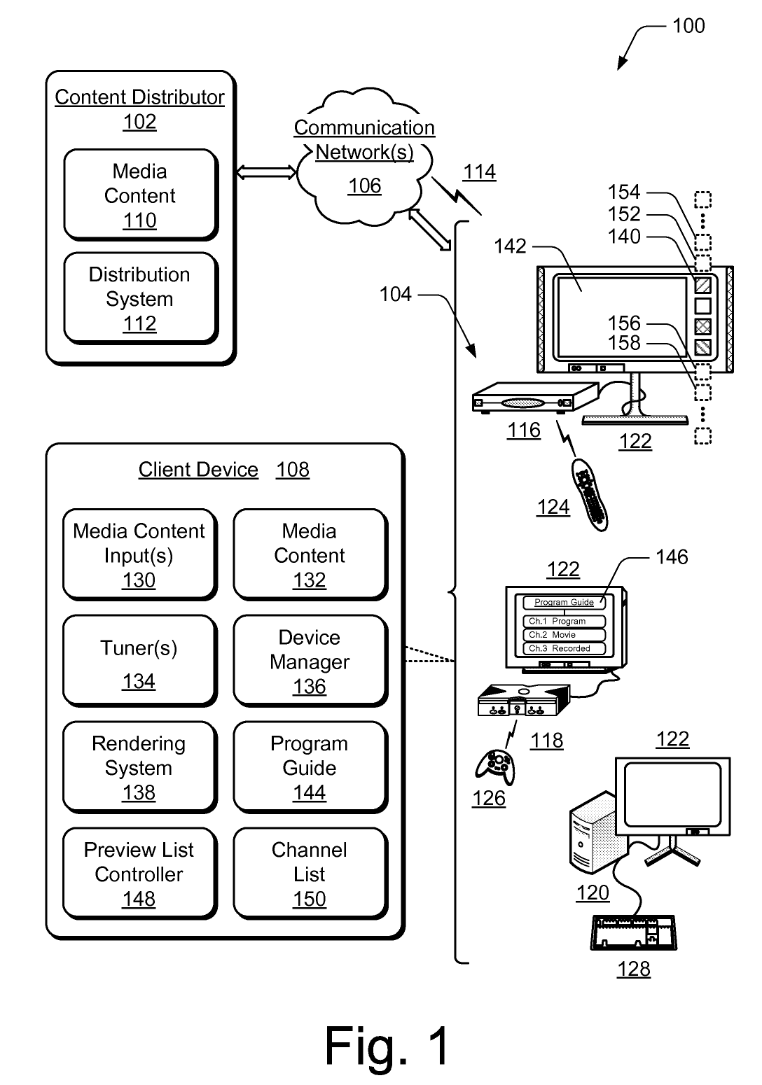

FIG. 1 illustrates an example system 100 in which various embodiments of seamlessly cycled video resources can be implemented. System 100 includes a content distributor 102 implemented for media content distribution and communication with various client devices 104 via communication networks 106. An example client device 108 is representative of the various client devices 104 that receive media content 110 when distributed from content distributor 102. In a media content distribution system, the content distributor 102 includes a distribution system 112 that facilitates distribution of media content, television content, metadata, and/or other associated data to multiple viewers, users, customers, subscribers, viewing systems, consumer devices, and/or client devices.

Media content (e.g., to include recorded media content) can include any type of audio, video, and/or image media content received from any media content source. As described herein, media content can include recorded video content, video-on-demand content, television content, television programs (or programming), advertisements, commercials, music, movies, video clips, and other media content. Other media content can include interactive games, network-based applications, and any other content or data (e.g., to include program guide application data, user interface data, advertising content, closed captions data, content metadata, search results and/or recommendations, etc.).

The communication networks 106 can include any type of a data network, voice network, broadcast network, an IP-based network, and/or a wireless network 114 that facilitates communication of data and media content in any format. The communication networks 106 can be implemented using any type of network topology and/or communication protocol, and can be represented or otherwise implemented as a combination of two or more networks. In addition, any one or more of the arrowed communication links facilitate two-way data communication.

The various client devices 104 in system 100 can be implemented as any one or combination of a wired and/or wireless device, as any form of television client device 116 (e.g., television set-top box, digital video recorder (DVR), etc.), gaming device 118, computer device 120, portable computer device, consumer device, media device, communication device, video processing and/or rendering device, appliance device, electronic device, and/or as any other type of device that can be implemented to receive media content in any form of audio, video, and/or image data. A client device may also be associated with a user (i.e., a person) and/or an entity that operates the device such that a device describes logical devices that include users, software, firmware, and/or a combination of devices.

The various client devices 104 in system 100 are also implemented as components in client systems that each include a respective display device 122. A client device and display device together render and playback any form of audio, video, and/or image content. A display device 122 can be implemented as any type of a television, high definition television (HDTV), LCD, or similar display system. The various client devices 104 (e.g., television, gaming, or computer devices) can also be associated with one or more input devices, such as a remote control device 124 for user-selectable inputs to the television client device 116, a gaming controller 126 for user-selectable inputs to the gaming device 118, and a keyboard 128 and/or mouse input devices for user-selectable inputs to the computer device 120.

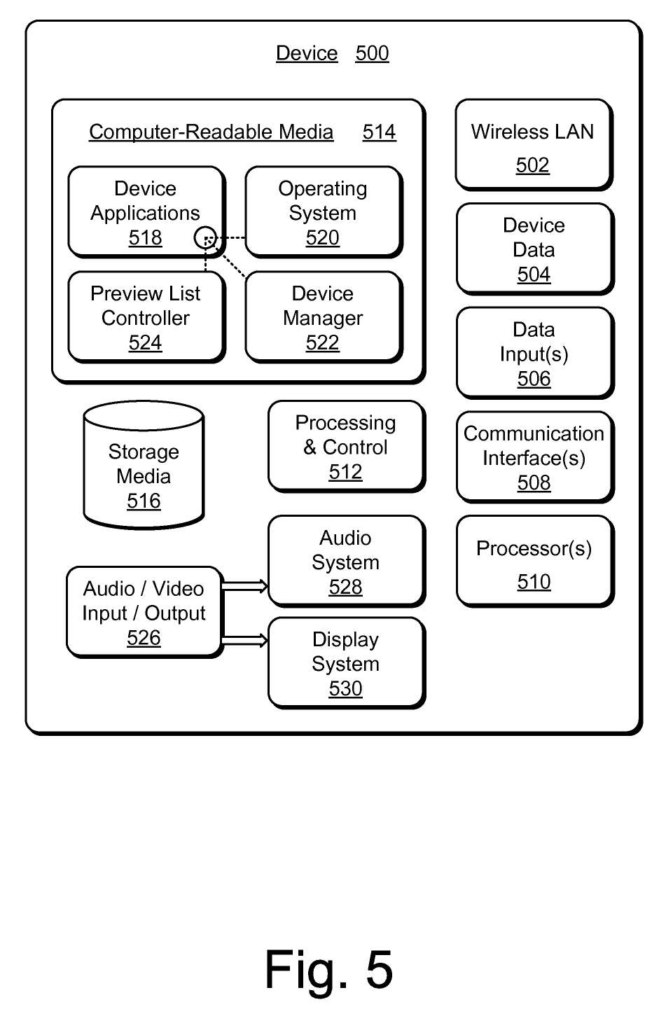

The example client device 108 is representative of the various client devices 104 that can implement embodiments of seamlessly cycled video resources. Any of the devices described herein can be implemented with one or more processors, communication components, data inputs, memory components, processing and control circuits, and/or a media content rendering system. A device can also be implemented with any number and combination of differing components as described with reference to the example device shown in FIG. 5.

In this example, client device 108 includes media content inputs 130 to receive media content 132 from content distributor 102. The media content inputs 130 can include any type of communication interfaces and/or data inputs, such as Internet Protocol (IP) inputs over which streams of television content (e.g., IPTV content) are received via an IP-based network. An IPTV receiver can include a media content input 130 to receive television content as an IPTV multicast via an Ethernet input port from content distributor 102. In addition, the media content inputs 132 can include any type of broadcast and/or over-the-air inputs via which media content is received over the air. Client device 108 also includes one or more tuners 134 to tune television channels for display and viewing. In embodiments, a tuner 134 can be implemented as a hardware tuner, or alternatively, as a software tuner that is implemented to tune to a television channel to display television media content for viewing.

Client device 108 is implemented with a device manager 136 that can include any one or combination of a control application, software application, signal processing and control module, code that is native to the particular device, and/or a hardware abstraction layer for the particular device. Client device 108 also includes a rendering system 138 to receive and render television content for display when received from the content distributor 102. The rendering system 138 is implemented to render program previews 140 for display, such as shown on the display device 122 that is associated with the television client device 116. The program previews 140 each correspond to a television channel that is user-selectable to initiate viewing a program.

In this example, the program previews 140 are each displayed as television media content (e.g., video and/or audio), such as in a picture-in-picture in addition to a main television channel that is displayed at 142 for viewing. When a program preview 140 is displayed on the display device 122, a viewer can select to initiate the audio that is associated with a particular program preview. The rendering system 138 is also implemented to render a program guide 144 for display on a display device 122 in the client systems. In this example, a media content program guide is displayed at 146 on the display device 122 that is associated with the gaming device 118. The program guide can include program previews displayed as text and/or video that corresponds to a respective program and an associated channel, and the program guide can display an additional program preview when a selection of a subsequent channel is received as a scroll input of the program guide.

In this example system 100, client device 108 includes a preview list controller 148 that can be implemented as computer-executable instructions and executed by processors to implement embodiments and/or features of seamlessly cycled video resources. In an implementation, the preview list controller 148 can be implemented as a component or module of the device manager 136. The client device 108 also includes a channel list 150 that is a list of the television channels corresponding to the media content received from the content distributor 102. The channel list 150 can be received from the content distributor 102 and/or generated as a user-selected list of television channels. The preview list controller 148 is also implemented to determine the program previews 140 for display from the channel list 150, and the program previews 140 can be displayed in a display configuration that represents the channel list 150 of the sequential channels that each correspond to a respective program preview.

The program previews 140 are displayed to correlate with the television channels that are listed in the channel list 150. A viewer can utilize an input device, such as remote control device 124, to scroll the program previews 140 to view a previous program preview 152 of a previous television channel and/or a previous program preview 154 of a television channel that is listed before the previous television channel in the channel list 150. Alternatively, the viewer can scroll the program previews 140 to view a subsequent program preview 156 of an additional television channel, and to view any number of successive program previews 158 for television channels that are listed after the additional television channel in the channel list 150. In this example, the program previews of the previous and subsequent television channels are not displayed (i.e., are outside of the visible scope), and are only shown to illustrate the correlation between the program previews and the television channels that are listed in the channel list 150. The subsequent and/or successive program previews can correlate numerically or temporally to the television channels that are listed in the channel list 150, such as consecutively numbered channels or various channels that are sequenced, but that are not sequential in number.

In embodiments, the preview list controller 148 is implemented to pre-tune television channels that are not displayed (i.e., outside of the visible scope), but just ahead of the scroll direction or direction that the program previews are being displayed for review by a viewer. The preview list controller 148 can determine a subsequent channel that is user-selectable to display a program preview 156 of an additional program, where the subsequent channel is determinable from the channel list 150 that sequentially lists the channels. The preview list controller 148 can then initiate a tuner 134 to pre-tune the subsequent channel that corresponds to the program preview of the additional program before the subsequent channel is selected to display the program preview 156. A viewer can then seamlessly cycle (e.g., scroll, select, etc.) through the program previews 140, in either direction, and the previous, subsequent, and/or successive program previews of additional programs are rendered for display without a viewer-perceptible delay when a selection of a television channel is received. In addition, the program previews 140 can scroll into and out of view on the display, and in an implementation, may include display animations as the viewer seamlessly cycles through the program previews.

In addition to television channels that are just outside of the visible scope being automatically pre-tuned, the preview list controller 148 initiates that channels corresponding to program previews no longer being displayed (i.e., those that are not in the visible scope) are de-tuned to conserve and reuse session resources, such as the tuner and memory that are allocated to display a program preview 140. The preview list controller 148 can also be implemented to reuse the internal tuning sessions and resources, such as the tuners 134 and blocks of memory. The preview list controller 148 can determine a last recently tuned channel, de-tune from the last recently tuned channel to release session resources, and then allocate the session resources to pre-tune a subsequent channel before the subsequent channel is selected. For example, as the program previews 140 are cycled or scrolled to display the subsequent program preview 156 and a successive program preview 158, the last recently tuned channels that correspond to the previous program previews 154 and 152 are de-tuned to reuse the tuning session resources allocated to those channels.

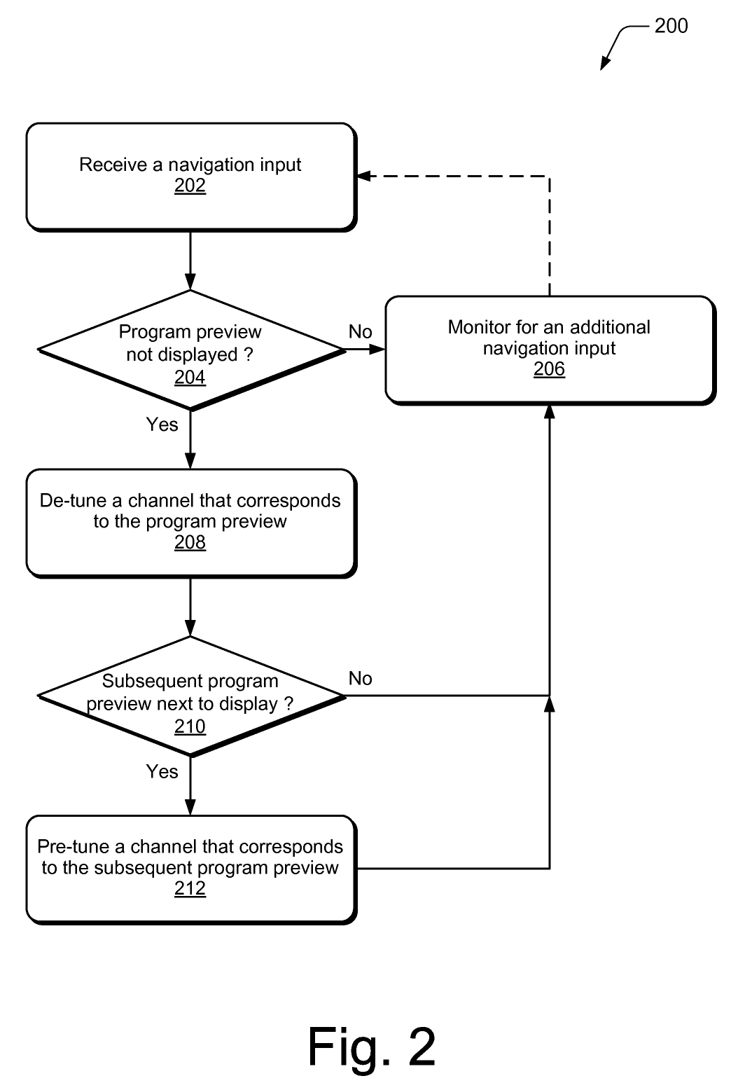

Example methods 200-400 are described with reference to respective FIGS. 2-4 in accordance with one or more embodiments of seamlessly cycled video resources. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. The example methods may be described in the general context of computer-executable instructions, which can include software, applications, routines, programs, objects, components, data structures, procedures, modules, functions, and the like.

The methods may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 2 illustrates example method(s) 200 of seamlessly cycled video resources. The order in which the method is described is not intended to be construed as a limitation, and any number of the described method blocks can be combined in any order to implement the method, or an alternate method.

At block 202, a navigation input is received. For example, a client device receives a navigation input when initiated by a viewer to scroll or cycle through program previews 140. A viewer can initiate the navigation input with an input device, such as the remote control device 124 for viewer input to the television client device 116, a gaming controller 126 for viewer input to the gaming device 118, and a keyboard 128 and/or mouse input devices for viewer input to the computer device 120.

At block 204, a determination is made as to whether a program preview is no longer displayed (e.g., no longer visible to a viewer). For example, the preview list controller 148 at client device 108 determines whether a television channel corresponding to a program preview 140 is no longer being displayed. If the program preview is still displayed after the navigation input is received (i.e., “no” from block 204), then at block 206, the client device monitors for an additional navigation input. For example, the preview list controller 148 at client device 108 monitors for an additional navigation input, such as received when initiated by a viewer at block 202.

If the program preview is no longer displayed (i.e., “yes” from block 204), then at block 208, a channel that corresponds to the program preview is de-tuned. For example, the preview list controller 148 at client device 108 initiates that channels corresponding to program previews no longer being displayed (i.e., those that are not in the visible scope) are de-tuned to conserve and reuse session resources, such as a tuner and memory that are allocated to display a program preview 140.

At block 210, a determination is made as to whether a subsequent program preview is next to display (e.g., the subsequent program preview is just outside of the visible scope). For example, the preview list controller 148 can determine a subsequent channel that is user-selectable to display a program preview 156 of an additional program, where the subsequent channel is determinable from the channel list 150 that sequentially lists the channels. The preview list controller 148 can then initiate a tuner 134 to pre-tune the subsequent channel that corresponds to the program preview of the additional program before the subsequent channel is selected to display the program preview 156.

If there is not a subsequent program preview that is next to display, (i.e., “no” from block 210), then at block 206, the client device monitors for an additional navigation input. For example, the preview list controller 148 at client device 108 monitors for an additional navigation input, such as received when initiated by a viewer at block 202.

If there is a subsequent program preview that is next to display (i.e., “yes” from block 210), then at block 212, a channel that corresponds to the subsequent program preview is pre-tuned. For example, the preview list controller 148 at client device 108 pre-tunes television channels that are not displayed (i.e., those that are outside of the visible scope of a display), but just ahead of the scroll direction or direction that the program previews are being displayed for review by a viewer. The method then continues at block 206 to monitor for an additional navigation input, such as received when initiated by a viewer at block 202.

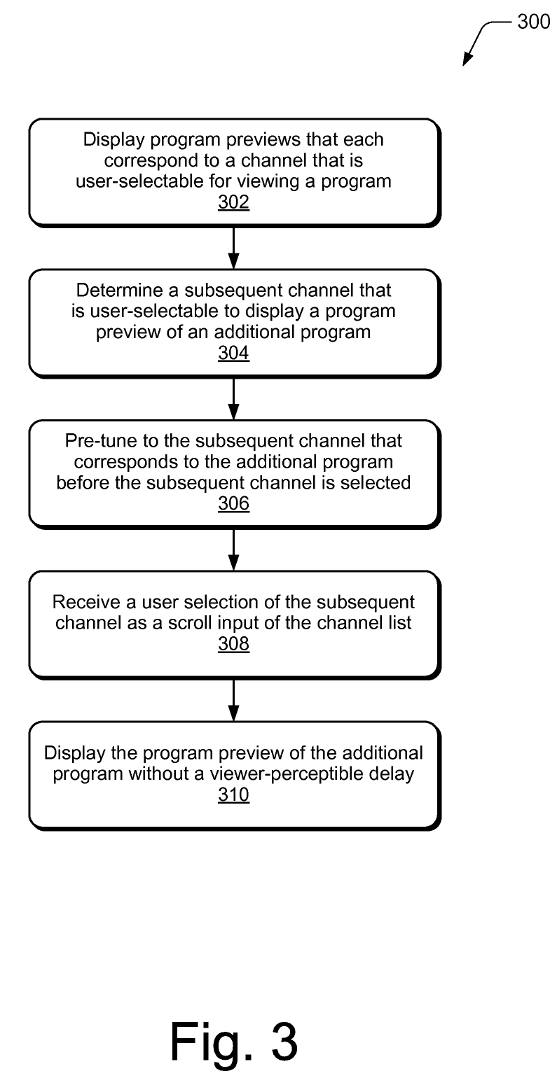

FIG. 3 illustrates example method(s) 300 of seamlessly cycled video resources. The order in which the method is described is not intended to be construed as a limitation, and any number of the described method blocks can be combined in any order to implement the method, or an alternate method.

At block 302, program previews are initiated for display and each corresponds to a channel that is user-selectable for viewing a program. For example, the rendering system 138 at client device 108 renders program previews 140 for display, such as shown on the display device 122 that is associated with the television client device 116. The program previews 140 each correspond to a television channel that is user-selectable to initiate viewing a program. The program previews 140 can each be displayed as television media content (e.g., video and/or audio), such as in a picture-in-picture in addition to a main television channel that is displayed at 142 for viewing. In an embodiment, the program previews 140 are displayed in a display configuration that represents the channel list 150 of the sequential channels that each correspond to a respective program preview. In another embodiment, a program guide 146 can include program previews displayed as text and/or video that corresponds to a respective program and an associated channel, and the program guide can display an additional program preview when a selection of a subsequent channel is received as a scroll input of the program guide.

At block 304, a subsequent channel is determined that is user-selectable to display a program preview of an additional program. In an embodiment, the subsequent channel is included in a channel list that sequentially lists the channels. For example, the preview list controller 148 at client device 108 determines a subsequent channel that is user-selectable to display a program preview 156 of an additional program, where the subsequent channel is determinable from the channel list 150 that sequentially lists the channels. Additionally, any number of successive channels can be determined that are user-selectable from the channel list 150 (e.g., successive channels that are listed sequentially after the subsequent channel in the channel list).

At block 306, the subsequent channel that corresponds to the additional program is pre-tuned before the subsequent channel is selected. For example, the preview list controller 148 initiates a tuner 134 to pre-tune the subsequent channel that corresponds to the program preview of the additional program before the subsequent channel is selected to display the program preview 156. Any additional or successive channels can also be pre-tuned before the channels are selected to initiate display of a program preview.

At block 308, a user selection of the subsequent channel is received as a scroll input of the channel list to display the program preview of the additional channel. At block 310, the program preview of the additional program is displayed without a viewer-perceptible delay when the selection of the subsequent channel is received. For example, a viewer can then seamlessly cycle (e.g., scroll, select, etc.) through the program previews 140, in either direction, and the subsequent and successive program previews of additional programs are rendered for display without a viewer-perceptible delay when a selection of a television channel is received.

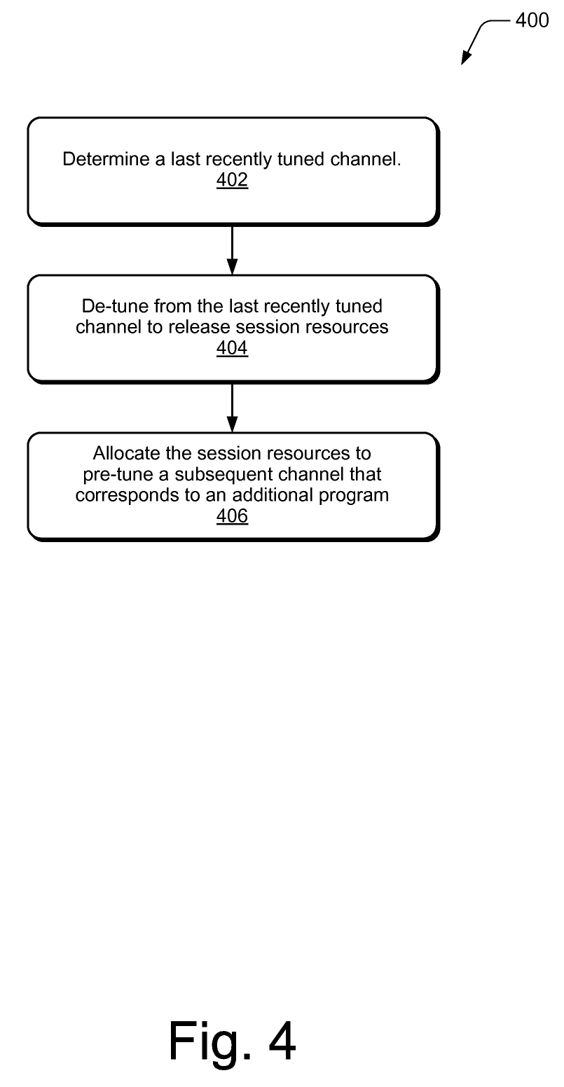

FIG. 4 illustrates example method(s) 400 of seamlessly cycled video resources. The order in which the method is described is not intended to be construed as a limitation, and any number of the described method blocks can be combined in any order to implement the method, or an alternate method.

At block 402, a last recently tuned channel is determined and, at block 404, the last recently tuned channel is de-tuned to release session resources. For example, the preview list controller 148 at client device 108 initiates that channels corresponding to program previews no longer being displayed (i.e., those that are not in the visible scope on a display) are de-tuned to conserve and reuse session resources, such as the tuner and memory that are allocated to display a program preview 140. The preview list controller 148 initiates reuse of the internal tuning sessions and resources, such as the tuners 134 and blocks of memory.

At block 406, the session resources are allocated to pre-tune a subsequent channel that corresponds to an additional program before the subsequent channel is selected. For example, the preview list controller 148 initiates a tuner 134 to pre-tune a subsequent channel that corresponds to a program preview of an additional program before the subsequent channel is selected to display the program preview, as described with reference to block 306 (FIG. 3).

FIG. 5 illustrates various components of an example device 500 that can be implemented as any type of client device and/or content distributor as described with reference to FIG. 1 to implement embodiments of seamlessly cycled video resources. In embodiment(s), device 500 can be implemented as any one or combination of a wired and/or wireless device, as any form of television client device (e.g., television set-top box, digital video recorder (DVR), etc.), consumer device, computer device, portable computer device, media device, communication device, video processing and/or rendering device, appliance device, gaming device, electronic device, and/or as any other type of device. Device 500 may also be associated with a user (i.e., a person) and/or an entity that operates the device such that a device describes logical devices that include users, software, firmware, and/or a combination of devices.

If implemented as a wireless device, the device 500 can include wireless LAN (WLAN) components 502 that enable wireless communication of device data 504 (e.g., received data, data that is being received, data scheduled for broadcast, data packets of the data, etc.). The device data 504 or other device content can include configuration settings of the device, media content stored on the device, and/or information associated with a user of the device. Media content stored on device 500 can include any type of audio, video, and/or image media content. Device 500 can also include one or more data inputs 506 via which any type of data, media content, and/or inputs can be received, such as music, television media content, recorded video content, and any other type of audio, video, and/or image content received from a content source which can then be processed, rendered, and/or displayed for viewing.

Device 500 can also include communication interfaces 508 that can be implemented as any one or more of a serial and/or parallel interface, a wireless interface, any type of network interface, a modem, and as any other type of communication interface. The communication interfaces 508 provide a connection and/or communication links between device 500 and a communication network by which other electronic, computing, and communication devices can communicate data with device 500.

Device 500 can include one or more processors 510 (e.g., any of microprocessors, controllers, and the like) which process various computer-executable instructions to control the operation of device 500 and to implement embodiments of seamlessly cycled video resources. Alternatively or in addition, device 500 can be implemented with any one or combination of hardware, firmware, or fixed logic circuitry that is implemented in connection with processing and control circuits which are generally identified at 512. Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 500 can also include computer-readable media 514, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like. Device 500 can also include a mass storage media device 516.

Computer-readable media 514 provides data storage mechanisms to store the device data 504, as well as various device applications 518 and any other types of information and/or data related to operational aspects of device 500. For example, an operating system 520 can be maintained as a computer application with the computer-readable media 514 and executed on processors 510. The device applications 518 can include a device manager 522 (e.g., a control application, software application, signal processing and control module, code that is native to a particular device, a hardware abstraction layer for a particular device, etc.). The device applications 518 can also include any system components or modules of a preview list controller 524 to implement embodiments of seamlessly cycled video resources. In this example, the device applications 518 are shown as software modules and/or computer applications.

Device 500 can also include an audio and/or video input-output system 526 that provides audio data to an audio system 528 and/or provides video data to a display system 530. The audio system 528 and/or the display system 530 can include any devices that process, display, and/or otherwise render audio, video, and image data. Video signals and audio signals can be communicated from device 500 to an audio device and/or to a display device via an RF (radio frequency) link, S-video link, composite video link, component video link, DVI (digital video interface), analog audio connection, or other similar communication link. In an embodiment, audio system 528 and/or the display system 530 can be implemented as external components to device 500. Alternatively, the audio system 528 and/or the display system 530 can be implemented as integrated components of example device 500.

Although embodiments of seamlessly cycled video resources have been described in language specific to features and/or methods, it is to be understood that the subject of the appended claims is not necessarily limited to the specific features or methods described. Rather, the specific features and methods are disclosed as example implementations of seamlessly cycled video resources.

1. A method implemented in a client device, the method comprising:
initiating a display of program previews that each correspond to a channel that is user-selectable for viewing a program;
determining a subsequent channel that is user-selectable to display a program preview of an additional program, the subsequent channel being included in a channel list that sequentially lists the channels; and
pre-tuning the subsequent channel that corresponds to the additional program before the subsequent channel is selected to display the program preview of the additional program.

2. A method as recited in claim 1, further comprising displaying the program preview of the additional program without a viewer-perceptible delay when a selection of the subsequent channel is received.

3. A method as recited in claim 1, further comprising receiving a user selection of the subsequent channel as a scroll input of the channel list to display the program preview of the additional channel.

4. A method as recited in claim 1, further comprising:
determining at least a successive channel that is user-selectable from the channel list, the successive channel being listed sequentially after the subsequent channel in the channel list; and
pre-tuning at least the successive channel before the successive channel is selected to initiate a display of a successive program preview.

5. A method as recited in claim 1, wherein the program previews are each displayed as a picture-in-picture in a display configuration that represents the channel list of the sequential channels that each correspond to a respective program preview.

6. A method as recited in claim 1, wherein the program previews are each displayed as television media content.

7. A method as recited in claim 1, wherein the program previews are each displayed in a program guide as text that corresponds to a respective program and an associated channel, and wherein the program preview of the additional program is displayed in the program guide when a selection of the subsequent channel is received as a scroll input of the program guide.

8. A method as recited in claim 1, further comprising:
determining a last recently tuned channel;
de-tuning from the last recently tuned channel to release session resources; and
allocating the session resources to pre-tune the subsequent channel that corresponds to the additional program before the subsequent channel is selected.

9. A client device, comprising:
a rendering system configured to render program previews for display, the program previews each corresponding to a channel that is user-selectable to initiate viewing a program;
multiple tuners each configured to tune to a channel;
a preview list controller configured to:
determine a subsequent channel that is user-selectable to display a program preview of an additional program, the subsequent channel determinable from a channel list that sequentially lists the channels; and
initiate a tuner to pre-tune the subsequent channel that corresponds to the additional program before the subsequent channel is selected to display the program preview of the additional program.

10. A client device as recited in claim 9, wherein the multiple tuners include at least one of hardware tuners or software implemented tuners.

11. A client device as recited in claim 9, wherein the rendering system is further configured to render the program preview of the additional program for display without a viewer-perceptible delay when a selection of the subsequent channel is received.

12. A client device as recited in claim 9, wherein the rendering system is further configured to initiate each of the program previews as a picture-in-picture in a display configuration that represents the channel list of the sequential channels that each correspond to a respective program preview.

13. A client device as recited in claim 9, wherein the rendering system is further configured to initiate a video display of each of the program previews as television media content.

14. A client device as recited in claim 9, further comprising a program guide configured to display the program previews as text that corresponds to a respective program and an associated channel, and wherein the program guide is further configured to display the program preview of the additional program when a selection of the subsequent channel is received as a scroll input of the program guide.

15. A client device as recited in claim 9, wherein the preview list controller is further configured to:
determine a last recently tuned channel;
de-tune from the last recently tuned channel to release session resources; and
allocate the session resources to pre-tune the subsequent channel that corresponds to the additional program before the subsequent channel is selected.

16. Computer-readable media having stored thereon computer-executable instructions that, if executed by a client device, initiate the client device to:
initiate a display of program previews that each correspond to a channel that is user-selectable for viewing a program;
determine a subsequent channel that is user-selectable to display a program preview of an additional program, the subsequent channel determinable from a channel list that sequentially lists the channels; and
initiate a tuner to pre-tune the subsequent channel that corresponds to the additional program before the subsequent channel is selected to display the program preview of the additional program.

17. Computer-readable media as recited in claim 16, wherein the computer-executable instructions, if executed, further initiate the client device to receive a selection of the subsequent channel and initiate display of the program preview of the additional program without a viewer-perceptible delay.

18. Computer-readable media as recited in claim 17, wherein the computer-executable instructions, if executed, further initiate the client device to receive the selection of the subsequent channel as a scroll input of the channel list.

19. Computer-readable media as recited in claim 16, wherein the computer-executable instructions, if executed, further initiate the client device to initiate the display of the program previews as television media content that represents the channel list of the sequential channels that each correspond to a respective program preview.

20. Computer-readable media as recited in claim 16, wherein the computer-executable instructions, if executed, further initiate the client device to:
determine a last recently tuned channel;
de-tune from the last recently tuned channel to release session resources; and
allocate the session resources to pre-tune the subsequent channel that corresponds to the additional program before the subsequent channel is selected.
